(19) United States
(12) Patent Application Publication
(10) Pub. No.: US 2014/0130417 A1
(43) Pub. Date: May 15, 2014

(54) SLIDING AND SWINGING DOOR SYSTEM

(71) Applicant: SUNFLEX ALUMINIUMSYSTEME GMBH, Wenden (DE)

(72) Inventors: Ernst-Josef Schneider, Wenden (DE); Malte Schneider, Naples, FL (US)

(73) Assignee: SUNFLEX ALUMINIUMSYSTEME GMBH, Wenden (DE)

(21) Appl. No.: 14/128,980

(22) PCT Filed: Jul. 5, 2012
(86) PCT No.: PCT/EP2012/063188

§ 371 Date: Dec. 23, 2013

(30) Foreign Application Priority Data
Jul. 14, 2011 (EP) 11005746.0

(51) Int. Cl. E06B 3/50

(52) U.S. Cl. CPC E06B 3/5072
USPC 49/177

(57) ABSTRACT

The invention relates to a sliding and swinging door system, comprising a rail profile in which at least two door leaves are mounted so as to be displaceable by way of two support elements, and which profile is provided with an expanding clamp for receiving a locking element disposed on a door leaf, in each instance, wherein at least one lateral outlet opening for release of a support element of a door leaf is disposed in the rail profile, at a distance from the expanding clamp, wherein at least one support part (6) is disposed on the rail profile (1), which part interacts with a pressure part (7) disposed on a door leaf (3), in each instance, in such a manner that when a support element (4) of a door leaf (3) is released, lateral tilting of the door leaf (3) is prevented, as long as the locking element (5) has not reached its stop point in the expanding clamp (2).

The invention relates to a sliding and swinging door system in accordance with the preamble of claim 1.

Such sliding and swinging door systems are sufficiently known. They have multiple displaceable casements, which can be pivoted individually, thereby making it possible for a front division or room division that is generally very large to be almost completely opened. The individual door leaves are guided to be displaceable in guide rails disposed on the ceiling and in the floor. In this connection, each door leaf is held on a ceiling profile so as to be displaceable by way of two support elements. For pivoting of a door leaf, the guide rail on the ceiling side has an outlet opening for release of a support element of a door leaf. On the end side, an expanding clamp is disposed in the guide rail on the ceiling side, into which clamp a locking element disposed on the door leaves, in each instance, is affixed. For pivoting of a door leaf, the locking element is moved into the expanding clamp, and the support element situated at the other end of the door leaf is released from the outlet opening and pivoted about the axis that runs through the locking element. In this connection, the locking element turns to move into a guide of the expanding clamp, so that the door leaf is securely held.

In this connection, the region in which the support element has just been released from the outlet opening is critical, whereby the locking element, however, has not yet reached its stop point in the expanding clamp. Here, the danger exists that the door leaf can tilt to the side, thereby causing the locking element to be moved out of the expanding clamp. In order to prevent such lateral tilting, it is known to dispose a projecting rail piece at the outlet opening, which holds the support element that has been released from the outlet opening, until the locking element has reached its stop point in the expanding clamp. However, this projecting rail element brings with it a risk of injury, and is furthermore perceived to be optically disruptive, because it projects into the room in the open and the closed state of the swinging and sliding door system.

This is where the invention wishes to provide a remedy. The present invention is based on the task of creating a swinging and sliding door system of the type stated above, in which lateral tilting of a door leaf is prevented when a support element is released, without the requirement of a projecting door leaf piece. According to the invention, this task is accomplished by means of the characteristics of the characterizing part of claim 1.

With the invention, a sliding and swinging door system of the type stated above is created, in which lateral tilting of a door leaf is prevented when a support element is released, without the requirement of a projecting rail part.

In a further development of the invention, the pressure part has a groove piece having an essentially T-shaped cross-section, with a guide plate provided on the side that lies opposite the cross-section, whereby the at least two door leaves are provided, on their top facing the rail profile, with a C profile that is open in the direction of the rail profile, into which the groove piece of the pressure part can be pushed. In this way, the pressure part can easily be positioned on the door leaf in the required location, in each instance.

In a further embodiment of the invention, the pressure part has at least one threaded bore for receiving a screw, orthogonal to its crosspiece, by way of which screw the pressure part can be braced within the C profile of a door leaf. In this way, simple fixation of the pressure part at the desired location of the door leaf is made possible.

In a further embodiment of the invention, the at least one support part is disposed laterally on the rail profile, between the outlet opening and the expanding clamp, so as to enclose the outer rail edge. In this way, the pressure part is enabled to slide behind when it is displaced in the rail profile. At the same time, disruptive projection of the support part is avoided.

In a further development of the invention, the rail profile is provided, in the longitudinal direction, on its side facing the outlet opening, with a crosspiece configured at a right angle, which piece engages into a slot-like recess of the support part. In this way, simple positioning and fixation of the support part at the desired location of the rail profile is made possible. In this connection, the right-angle crosspiece is preferably formed by a C-profile-like formation of the rail profile.

In a further embodiment of the invention, the support part has at least one threaded bore for receiving a screw, orthogonal to the slot-like recess, by way of which bore the support part can be braced in the C-profile-like recess. In this way, simple fixation of the support part on the rail profile is made possible during the course of installation.

Other further developments and embodiments of the invention are indicated in the other dependent claims. An exemplary embodiment of the invention is shown in the drawings and will be described in detail below. The drawings show:

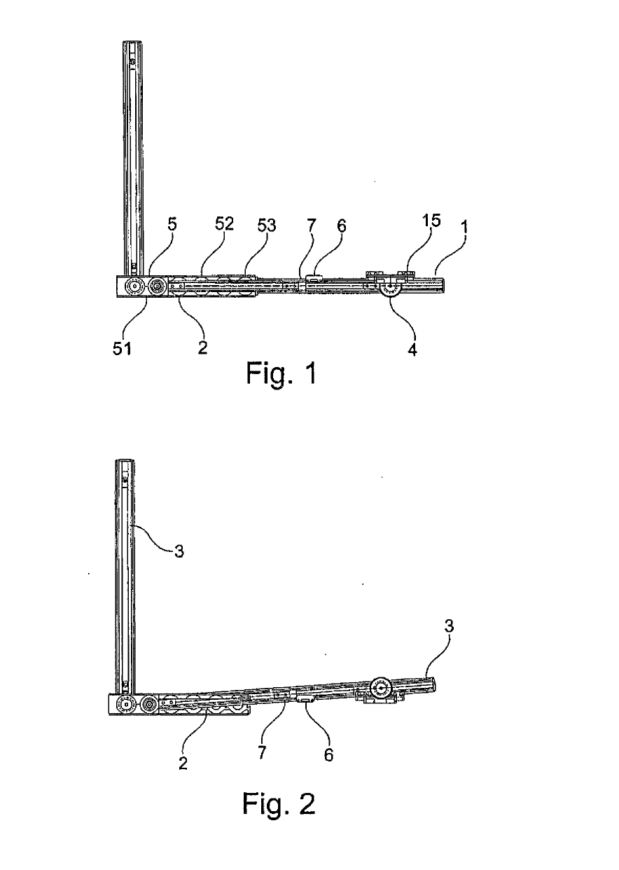

FIG. 1 the schematic representation of a sliding and swinging door system in a view from above;

FIG. 2 the representation of the sliding and swinging door system from FIG. 1 in a position of the support part of a door leaf in which it has just been released;

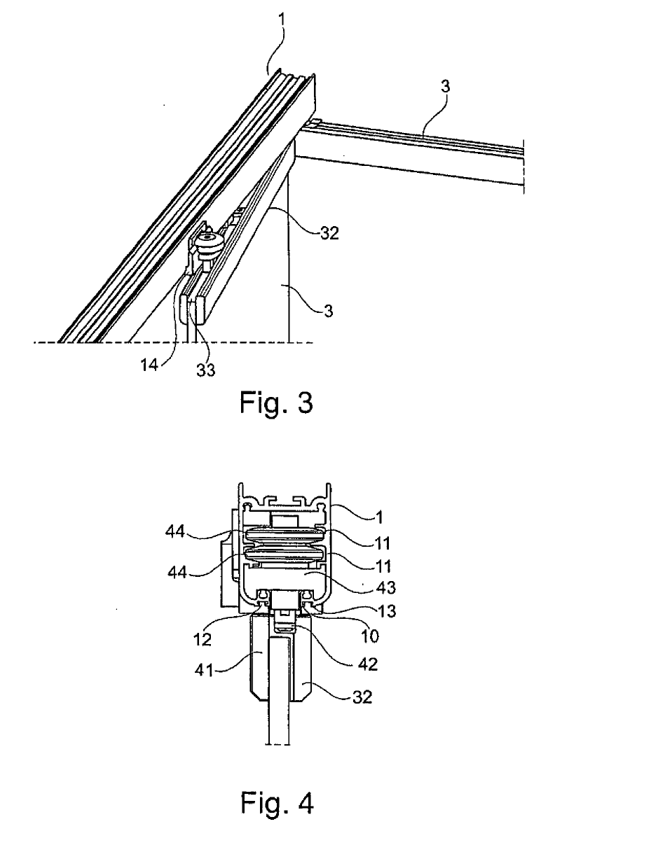

FIG. 3 the spatial representation of the door leaf position of the sliding and swinging door system according to FIG. 2;

FIG. 4 the schematic representation of the engagement of a support part of a door leaf into a rail profile, in cross-section;

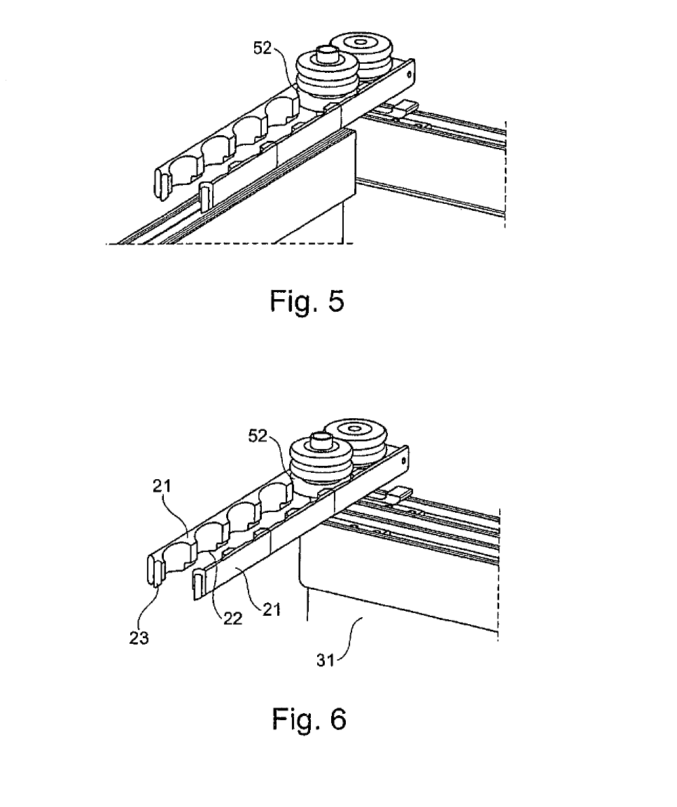

FIG. 5 the detail representation of the engagement of a locking element of a door leaf before pivoting, and

FIG. 6 the representation of the engagement of the locking element of a door leaf into an expanding clamp after pivoting of the door leaf.

The sliding and swinging door system selected as an exemplary embodiment consists essentially of a rail profile 1 that is provided with an expanding clamp 2 at its end side, and of a number of door leaves 3 that are guided by way of support parts 4, so as to be displaceable in the rail profile 1. On the floor side, the door leaves 3 are also guided in a floor profile—not shown.

The rail profile 1 is configured essentially in the manner of a C profile. Furthermore, guide grooves 11 for receiving the guide rollers 44 of the support parts 4 of the door leaves 3 are disposed in the rail profile 1, lying opposite one another on its side walls. A C-profile-like formation 12 is formed on its lower, open side, on both sides of the passage 10 formed by the C-profile-like rail profile 1, thereby forming crosspieces 13 configured at right angles. An outlet opening 14 for release of a support part 4 of a door leaf 3 is introduced laterally into the rail profile 1, which opening is surrounded by a guide frame 5.

The expanding clamp 2 is configured as a pincer-shaped plastic part. In the arms 21 of the expanding clamp 2, arc-shaped formations 22 that follow one another are disposed, which formations are introduced approximately centered with a groove 23 for receiving the locking plate 52 of the locking element 5. The radius of the arc-shaped formation 2 essentially corresponds to the radius of the guide rollers 44 of the support parts 4.

The door leaves 3 are formed from a panel element 31, in each instance, which is enclosed by profiles 32 at the end sides. The profile 32 of the door leaf 3 that faces the rail profile 1 has a C-profile-like formation 33 for receiving the groove plates 42 of the support parts 4. In the exemplary embodiment, each door leaf 3 is provided with two support parts 4, which are introduced into the C-profile-like formation 33 of the profile 32 of the door leaf 3. A pressure part 7 is furthermore introduced into the C-profile-like formation 33, between the two support parts 4.

The support part 4 is essentially formed by a cylinder part 41 that is disposed at the end side, with a groove plate 42 for engagement into the C-profile-like formation 33 of the profile 32 of a door leaf 3. A guide plate 43, on which two guide rollers 44 are mounted on the cylinder part 41, so as to rotate, is formed on opposite the groove plate 3.

Furthermore, a locking element 5 is introduced into the C-profile-like formation 33 of the profile 32 of each door leaf 3. The locking element 5 is essentially formed by a groove piece 51 that engages into the C-profile-like formation 33 of the door leaf 3. A locking plate 52 is formed onto the groove piece 51, which plate is formed essentially in the manner of a rectangle with narrow sides configured in arc shape. Two threaded bores 33 for receiving a screw are introduced into groove piece 51, to brace the groove piece 51 of the locking element 5 in the C-profile-like formation 33 of a door leaf 3.

The support part 6 is configured essentially in block shape, whereby one longitudinal edge is formed in such a manner that its inner contour corresponds to the outer contour of a longitudinal edge of the rail profile 1. The support part is disposed laterally on the outer edge of the rail profile 1, between the outlet opening 14 and the expanding clamp 2, enclosing the outer edge of the rail profile. In this connection, a slot-like recess—not shown—is introduced into the support part 6, into which recess a crosspiece formed by the C-profile-like formation 12 of the rail profile 1 engages. Two threaded bores 61 for receiving a screw are introduced into the support part 6, orthogonal to the slot-like recess—not shown—by way of which bores the support part 6 can be braced in the C-profile-like formation 12 of the rail profile 1.

The pressure part 7 consists essentially of a groove piece 71 for introduction into the C-profile-like formation 33 of a door leaf 3, as well as a rounded-off guide plate 72 formed onto this piece, which plate interacts with a support part 6 disposed on the rail profile 1.

For pivoting of a door leaf 3 of the sliding and swinging door system, the door leaf 3 is first displaced along the rail profile 1 until the locking element 5 engages into the free formation 22 of the expanding clamp 2 that lies farthest away. In this position, the support part 4 disposed at the opposite end of the door leaf 3 is situated at the outlet opening 14 of the rail profile 1. The pressure part 7 is moved past behind the support part 6 during displacement of the door leaf 3 within the rail profile 1. If the door leaf 3 is subsequently pivoted about the axis of rotation that runs through the locking element 5, then the support part situated at the outlet opening 14 is released out of this opening, whereby the pressure part 7 of the door leaf 3 is moved along the support part 6 disposed on the rail profile 1, thereby avoiding tilting of the door leaf 3. At the same time, the locking plate 52 of the locking element 5 is turned to move into the grooves 23 of the opposite formations 22 of the arms 21 of the expanding clamp 2. After the locking plate 52 of the locking element 5 engages into the grooves 23 of the expanding clamp 2, thereby causing the locking element to reach its stop point, the pressure part 7 of the door leaf 3 is moved past the support part 6 of the rail profile 1 during the further course of the pivoting movement of the door leaf 3, until it is positioned approximately at a right angle to the rail profile 1. Subsequently, the further door leaves can be released analogously and pivoted to lie against the first door leaf.

Because of the fixed arrangement of the outlet opening 14 in the rail profile in the rail profile 1 and the raster of the formations 22 of the expanding clamp 2, the support parts 4 and the pressure part 7 are positioned at different locations on the individual door leaves 3. Only the locking element 5, through which the axis of rotation of the door leaf 3 runs, is positioned at the same location on every door leaf. In the case of a greater number of door leaves, it can be necessary to dispose two support parts 6, spaced apart from one another, on the rail profile 1.

In an alternative embodiment, it is also possible to structure the support part 6 or the pressure part 7 in the form of a roller that glides along a pressure part 7 or support part 6, configured accordingly as a guide. It is furthermore possible to form support part 6 and pressure part 7 as permanent magnets that have the same pole, in other words repel one another.

1. Sliding and swinging door system, comprising a rail profile in which at least two door leaves are mounted so as to be displaceable by way of two support elements, and which profile is provided with an expanding clamp for receiving a locking element disposed on a door leaf, in each instance, wherein at least one lateral outlet opening for release of a support element of a door leaf is disposed in the rail profile, at a distance from the expanding clamp, wherein at least one support part (6) is disposed on the rail profile (1), which part interacts with a pressure part (7) disposed on a door leaf (3), in each instance, in such a manner that when a support element (4) of a door leaf (3) is released, lateral tilting of the door leaf (3) is prevented, as long as the locking element (5) has not reached its stop point in the expanding clamp (2).

2. Sliding and swinging door system according to claim 1, wherein the pressure part (7) has a groove piece (71) having an essentially T-shaped cross-section, on which piece a guide plate (72) is provided on the side that lies opposite the crosspiece, wherein the at least two door leaves (3) are provided, on their top facing the rail profile (1), with a C profile that is open in the direction of the rail profile (1), into which the groove piece (71) of the pressure part (7) can be pushed.

3. Sliding and swinging door system according to claim 2, wherein the pressure part (7) has at least one threaded bore (73) for receiving a screw, orthogonal to its crosspiece, by way of which screw the pressure part (7) can be braced within the C profile of a door leaf (3).

4. Sliding and swinging door system according to claim 1, wherein the at least one support part (6) is disposed laterally on the rail profile (1), between the outlet opening (14) and the expanding clamp (2), so as to enclose the outer rail edge.

5. Sliding and swinging door system according to claim 4, wherein the rail profile (1) is provided, in the longitudinal direction, on its side facing the outlet opening (14), with a crosspiece (13) configured at a right angle, which piece engages into a slot-like recess of the support part (6).

6. Sliding and swinging door system according to claim 5, wherein the crosspiece (13) configured at a right angle is formed by a C-profile-like formation (12) of the rail profile (1).

7. Sliding and swinging door system according to claim 6, wherein the support part (6) has at least one threaded bore (61) for receiving a screw, orthogonal to the slot-like recess, by way of which screw the support part (6) can be braced within the C-profile-like formation (12).
